(19) United States
(12) Patent Application Publication
(10) Pub. No.: US 2014/0084148 A1
(43) Pub. Date: Mar. 27, 2014

(54) OPTICAL-QUALITY COVER FOR USE WITH AN OPTICAL COUPLING SYSTEM, AND AN OPTICAL COMMUNICATIONS MODULE THAT INCORPORATES THE OPTICAL-QUALITY COVER

(71) Applicant: Avago Technologies General IP (Singapore) Ptd. Ltd., Singapore (SG)

(72) Inventors: Bing Shao, Sunnyvale, CA (US); Ye Chen, San Jose, CA (US)

(73) Assignee: Avago Technologies General IP (Singapore) Pte. Ltd., Singapore (SG)

(21) Appl. No.: 14/068,477

(22) Filed: Oct. 31, 2013

Related U.S. Application Data
(63) Continuation-in-part of application No. 13/629,146, filed on Sep. 27, 2012.

(51) Int. Cl. H04B 10/50; G02B 6/42

(52) U.S. Cl. CPC H04B 10/501; G02B 6/4206
USPC 250/237 G; 385/37; 385/33

(57) ABSTRACT

In an optical communications module, an optical-quality (O-Q) cover is provided for use with an optical coupling system for protecting a diffractive grating of the optical coupling system from environmental contamination. In accordance with illustrative embodiments, the O-Q cover is used with an optical coupling system that includes a unitary, or integrally-formed, optical body having lenses formed on its lower end and a diffractive grating formed on its upper end. The O-Q cover is disposed in proximity to the diffractive grating and is mechanically coupled to the optical coupling system in a way that seals the portion of the optical coupling system comprising the diffractive grating in order to protect the diffractive grating from environmental contamination.

### CROSS-REFERENCE TO RELATED APPLICATIONS

This application is a continuation-in-part (CIP) application of and claims priority to U.S. application Ser. No. 13/629,146, filed on Sep. 27, 2012, and entitled “AN OPTICAL COUPLING SYSTEM, AN OPTICAL COMMUNICATIONS MODULE THAT INCORPORATES THE OPTICAL COUPLING SYSTEM, AND A METHOD OF USING THE OPTICAL COUPLING SYSTEM,” which is incorporated herein by reference in its entirety.

### TECHNICAL FIELD OF THE INVENTION

The invention relates to optical communications networks, and more particularly, to an optical-quality cover for use with an optical coupling system of an optical communications module.

### BACKGROUND OF THE INVENTION

An optical transmitter (TX) module is a type of optical communications module used to transmit optical data signals over optical waveguides (e.g., optical fibers) of an optical communications network. An optical TX module includes input circuitry, a laser driver circuit, one or more laser diodes, and an optical coupling system. The input circuitry typically includes buffers and amplifiers for conditioning an input data signal, which is then provided to the laser driver circuit. The laser driver circuit receives the conditioned input data signal and produces electrical modulation and bias current signals, which are provided to the laser diodes to cause them to produce optical data signals having logic 1 and logic 0 intensity levels. The optical data signals are then directed by the optical coupling system onto the ends of respective transmit optical fibers held within a connector that mates with the optical transceiver module.

Optical TX modules often also include a closed loop optical output power feedback system that monitors and controls the modulation and/or bias currents of the laser diodes in such a way that the average optical output power levels of the laser diodes are maintained within a particular range. In closed loop optical output power feedback systems, the optical coupling system of the TX module couples a portion of the light produced by the laser diodes onto respective monitor photodiodes of the TX module. The monitor photodiodes produce electrical signals corresponding to the optical output power levels of the laser diodes. Electrical feedback circuitry of the feedback system receives the electrical signals produced by the monitor photodiodes and produces control signals that are then used to adjust the modulation and/or bias currents of the laser diodes such that their average optical output power levels are maintained at designed levels.

Many optical coupling systems currently in use in optical TX modules incorporate relatively elaborate optical features for providing optical feedback, such as gratings at the entrance surface for dividing the light beam and a coated flat surface or angled surface at the exit surface for reflecting a portion of the divided light beam onto the optical feedback monitoring path. Manufacturing these types of optical features tends to be difficult and costly due to the complexity of the manufacturing processes. Diffractive optics systems are typically fabricated on a glass lens, which is a relatively expensive manufacturing process. Diffractive optics systems typically include a diffraction grating and collimating lens on the entrance surface for dividing the light beam produced by the laser diode and for collimating a portion of the divided light beam to be transmitted and a reflective surface on the exit surface for reflecting a portion of the divided light beam onto the monitor photodiode. Particular locations on the upper and or lower surfaces of the optical coupling system are sometimes coated with a light-absorbing material to reduce optical crosstalk to the laser diodes. Although diffractive optics could potentially be fabricated in plastic using a plastic molding process, such plastic molding technologies are not yet mature enough to fabricate all of the optical features that are needed to perform all of these functions.

The functions of dividing the optical beam and reducing optical crosstalk can also be accomplished by tilting the interface at which the optical beam output from the laser diode enters the optical coupling system. This is not an option, however, for cases where the monitor photodiode arrays are located on either side of the laser diode array due to difficulties that such a layout presents with designing and fabricating the pluggable optical connector that holds the ends of the optical fibers. In addition, tilting the interface makes alignment inspection more difficult to perform.

A need exists for an optical coupling system for use in an optical TX module for optical feedback monitoring that has high optical coupling efficiency, low optical crosstalk susceptibility, little or no polarization dependency, and that can be manufactured at relatively low costs.

### SUMMARY OF THE INVENTION

The invention is directed to an optical communications module that includes an optical-quality (O-Q) cover for protecting a diffractive grating of an optical coupling system of the module from contaminants. The optical communications module comprises a holder, an optical coupling system, at least one optoelectronic component, and the O-Q cover. The holder is adapted to hold the optical coupling system. The holder has an upper surface in which a recessed area has been formed. The recessed area has an opening formed therein that defines a ledge. The optical coupling system is secured to the holder beneath the opening. The optical coupling system is transparent to light of an operating wavelength and has at least an upper surface, a lower surface, and side walls. A diffractive grating is formed in the upper surface of the optical coupling system. The O-Q cover is secured to an upper surface of the ledge such that the cover covers the opening formed in the recessed area of the holder. The cover is transparent to light of an operating wavelength. The diffractive grating is spaced apart from the lower surface of the cover by a predetermined distance, D. The cover protects the diffractive grating from contaminants in the external environment.

These and other features and advantages of the invention will become apparent from the following description, drawings and claims.

### BRIEF DESCRIPTION OF THE DRAWINGS

FIG. 1A illustrates the optical coupling system in accordance with an illustrative embodiment, which comprises a unitary plastic body having a at least one collimating lens formed on a first end of the body and having a sinusoidal diffractive grating formed on a second end of the body.

FIG. 1B illustrates an expanded view of the portion of the grating that is within the dashed box shown in FIG. 1A.

FIG. 2A illustrates the optical coupling system in accordance with an illustrative embodiment, which comprises a unitary plastic body having at least one collimating lens formed on a first end of the body and having a blaze diffractive grating formed on a second end of the body.

FIG. 2B illustrates an expanded view of the portion of the grating that is within the dashed box in FIG. 2A.

FIGS. 3A and 3B illustrate front and side plan views, respectively, of a parallel optical transmitter module that includes an optical coupling system in accordance with an illustrative embodiment of the invention.

FIGS. 4A, 4B and 4C illustrate top, front and bottom plan views, respectively, of the optical coupling system in accordance with an illustrative embodiment.

FIGS. 5A and 5B illustrate front and side views, respectively, of a four-channel optical transceiver module mechanically coupled to an optical connector that holds ends of four optical fibers.

FIGS. 6A, 6B and 6C illustrate top, front and bottom plan views, respectively, of the optical coupling system in accordance with an illustrative embodiment.

FIGS. 7A and 7B illustrate front and side plan views, respectively, of a parallel optical transmitter module that includes an O-Q cover in accordance with an illustrative embodiment.

FIG. 8 illustrates a cross-sectional side view of the cover, the holder and the optical coupling system shown in FIG. 7A.

### DETAILED DESCRIPTION OF AN ILLUSTRATIVE EMBODIMENT

In accordance with the invention, an optical-quality (O-Q) cover is provided for use with an optical coupling system for protecting a diffractive grating of the optical coupling system from environmental contamination. In accordance with illustrative embodiments, the O-Q cover is used with an optical coupling system that includes a unitary, or integrally-formed, optical body having lenses formed on its lower end and a diffractive grating formed on its upper end. The O-Q cover is disposed in proximity to the diffractive grating and is mechanically coupled to the optical coupling system in a way that seals the portion of the optical coupling system comprising the diffractive grating in order to protect the diffractive grating from environmental contamination. The material of which the O-Q cover is made and the structure of the O-Q cover are such that upper and lower surfaces of the cover remain parallel to one another under stress so that the cover does not produce a lens effect. The material of which the O-Q cover is made is sufficiently strong to prevent the cover from being bent by stresses that are applied to the cover so that the cover does not produce a lens effect, but is not so thick that the cover attenuates an appreciable amount of light of an operating wavelength. At least a portion of the O-Q cover acts as an optical window that is transparent to light of the operating wavelength.

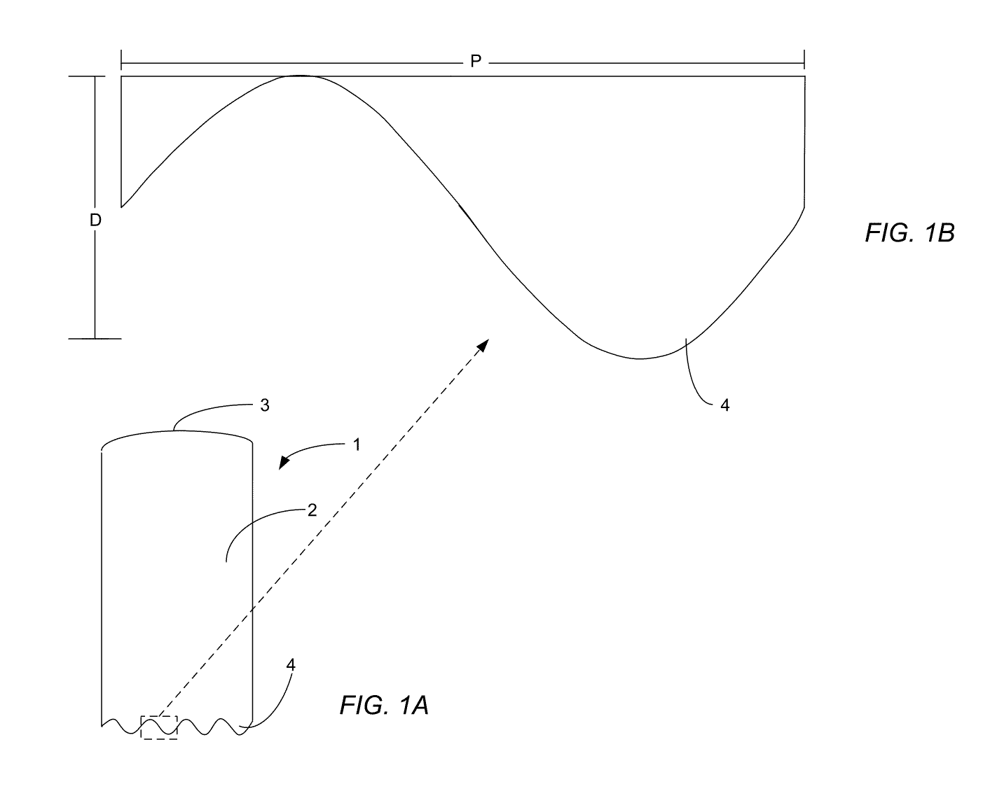

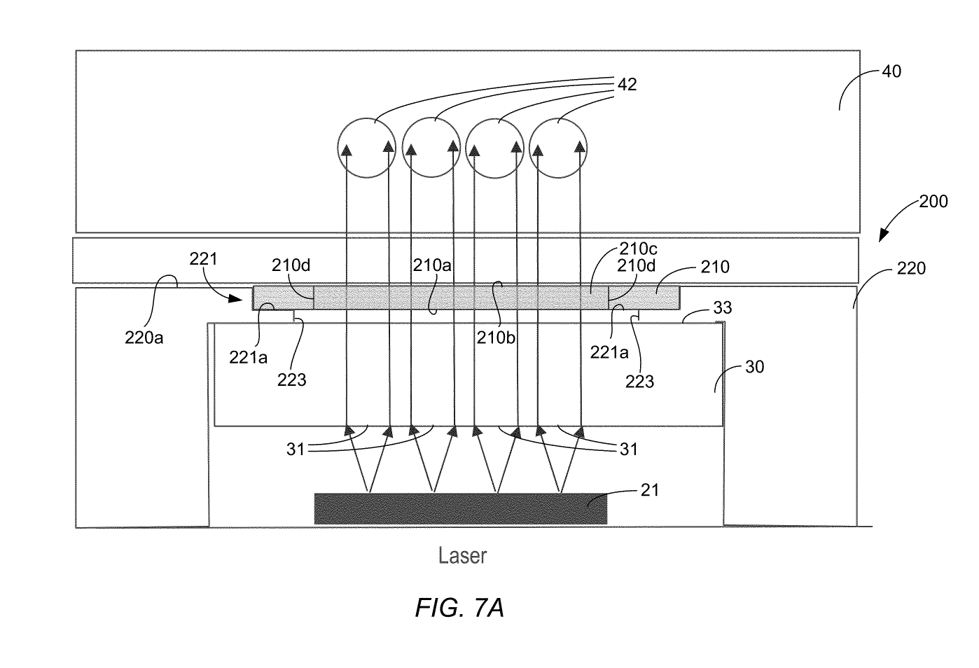

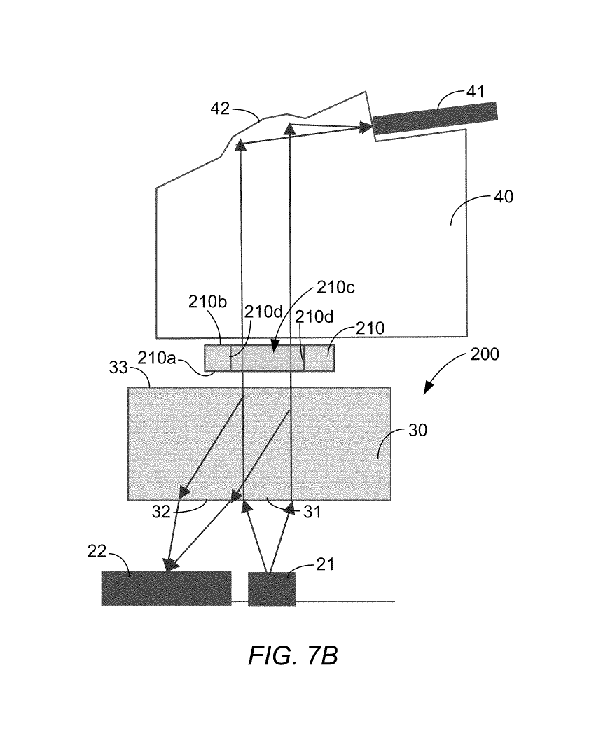

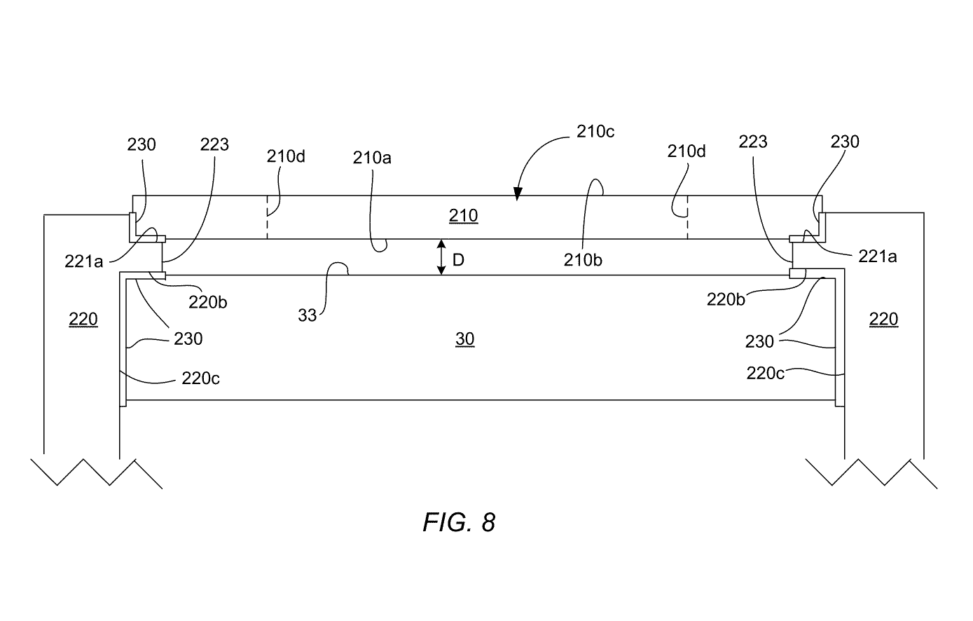

Prior to describing illustrative embodiments of the O-Q cover, illustrative embodiments of the optical coupling system with which the O-Q cover may beneficially be used will be described with reference to FIGS. 1A-6C. Illustrative embodiments of the O-Q cover will then be described with reference to FIGS. 7A-8. Like reference numerals in FIGS. 1A-8 represent like elements, features or components.

In accordance with illustrative embodiments, the unitary optical body comprising the optical coupling system is made of a material that is transparent to an operating wavelength of light. With respect to the lenses that are formed on the lower end of the body, some of the lenses are collimating lenses and some of the lenses are focusing lenses. The optical coupling system is incorporated into a parallel optical communications system that may be a parallel optical transmitter, receiver or transceiver. For exemplary purposes, it will be assumed that the parallel optical communications module is a parallel optical transmitter. Diverging light beams emitted by respective laser diodes of the parallel optical transmitter module are incident on the respective collimating lenses, which collimate the respective diverging light beams to produce respective collimated light beams. The respective collimated light beams are then incident on the diffractive grating. The diffractive grating divides each collimated beam into a first beam that is transmitted through the grating and a second beam that is reflected by the grating. Each reflected second beam is directed by the grating onto a respective focusing lens, which focuses the respective second beam onto the respective monitor photodiode of the transmitter module. As will be described below with reference to FIGS. 7A-8, the O-Q cover is made of a material that is transparent to the operating wavelength(s) of the laser diodes such that the first beam that is transmitted through the grating passes through the O-Q cover without being attenuated or reflected to any appreciable extent.

In accordance with illustrative embodiment, the diffractive grating is designed and manufactured to minimize the optical power that is contained in higher diffractive orders so that the optical power that is contained in the first beams, which are the 0 transmitted (0T) orders, and the optical power that is contained in the second beams, which are the −1 reflected (−1R) orders, is maximized while minimizing the amount of optical power that is contained in the light beams that are reflected back to the laser diodes, which are the 0 reflected (0R) orders.

In addition, the diffractive grating preferably is also designed and manufactured to minimize polarization dependence of the 0T orders. This latter feature reduces or eliminates polarization-dependent noise that may otherwise occur when a laser diode changes modes. Reducing or eliminating polarization-dependent noise minimizes mode-selective loss.

In accordance with illustrative embodiments, the optical coupling system is formed as a unitary, or integral, plastic part using existing plastic molding techniques. The plastic material may be, for example, polyetherimide (PEI). One moldable brand of PEI that is suitable for this purpose is ULTEM 1010 PEI, although many other PEIs and other plastics, such as Polyethersulfone (PES), and High Temperature Light Transmissible Thermoplastics (HTLT™), for example, may also be suitable for this purpose. Making the optical coupling system as a unitary plastic part allows the optical coupling system to be manufactured at low cost with high yield while still achieving the optical goals of the invention.

The diffraction grating may have a relatively simple diffractive pattern formed in it, such as a sinusoidal pattern or a blaze pattern, although the invention is not limited to any particular type of diffractive pattern. Sinusoidal patterns and blaze patterns are advantageous in that they can be manufactured relatively easily in plastic using existing plastic molding techniques. During the process of designing the diffractive grating, the shape, pattern, period, and depth of the diffractive pattern are selected to achieve the aforementioned optical goals and to accommodate the layout requirements of the laser diodes and monitor photodiodes (e.g., the distance between the laser diodes and the monitor photodiodes and their relative positions).

FIG. 1A illustrates the optical coupling system 1 in accordance with an illustrative embodiment, which comprises a unitary plastic body 2 having an aspheric collimating lens 3 formed on a first end of the body 2 and a sinusoidal diffractive grating 4 formed on a second end of the body 2. FIG. 1B illustrates an expanded view of the portion of the grating 4 that is within the dashed box in FIG. 1A. The unitary plastic body 2 is transparent to the wavelength of light upon which it is intended to operate. In accordance with this exemplary embodiment, the sinusoidal diffractive grating 4 has a depth, D, of between about 0.3 and 0.4 micrometers (microns) and a period, P, of between about 2.0 and 3.0 microns. Using these values for the depth and period of the sinusoidal diffractive grating results in a diffraction efficiency for the 0T mode of about 89%, a diffraction efficiency for the −1R order mode of about 2% and a diffraction efficiency for the 0R order mode of about 0.8%. This meets the aforementioned optical goals of minimizing the optical power that is contained in higher diffractive orders so that the optical power that is contained in the first beams (the 0T orders) and in the second beams (the −1R orders) is maximized while minimizing the amount of optical power that is contained in the light beams that are reflected back to the laser diodes (the 0R orders).

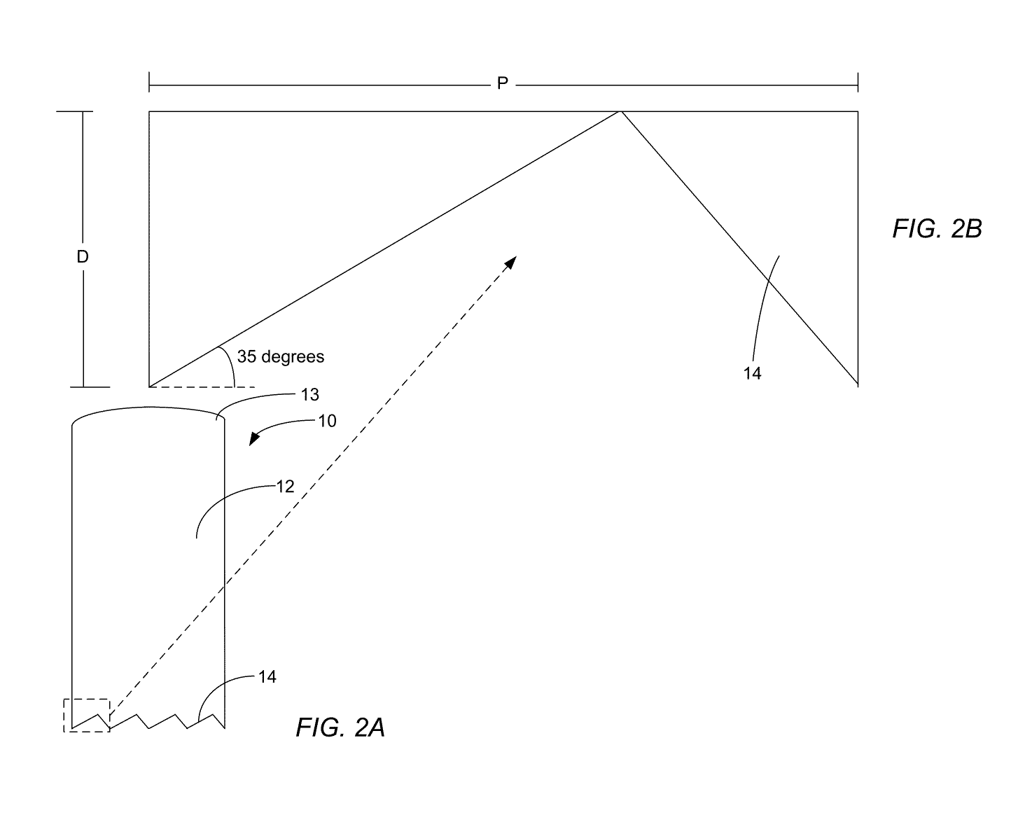

FIG. 2A illustrates the optical coupling system 10 in accordance with an illustrative embodiment, which comprises a unitary plastic body 12 having an aspheric collimating lens 13 formed on a first end of the body 12 and a blaze diffractive grating 14 formed on a second end of the body 12. FIG. 2B illustrates an expanded view of the portion of the grating 14 that is within the dashed box in FIG. 2A. In accordance with this exemplary embodiment, the blaze diffractive grating 14 has a depth, D, of between about 0.4 and 0.5 microns, a period, P, of between about 2.0 and 3.0 microns, and a blaze angle of about 35°. Using these values for the diffractive blaze grating results in a diffraction efficiency for the 0T mode of about 88%, a diffraction efficiency for the −1R order mode of about 2.8% and a diffraction efficiency for the 0R order mode of about 0.6%. This meets the aforementioned optical goals of minimizing the optical power that is contained in higher diffractive orders so that the optical power that is contained in the first beams (the 0T orders) and in the second beams (the −1R orders) is maximized while minimizing the amount of optical power that is contained in the light beams that are reflected back to the laser diodes (the 0R orders).

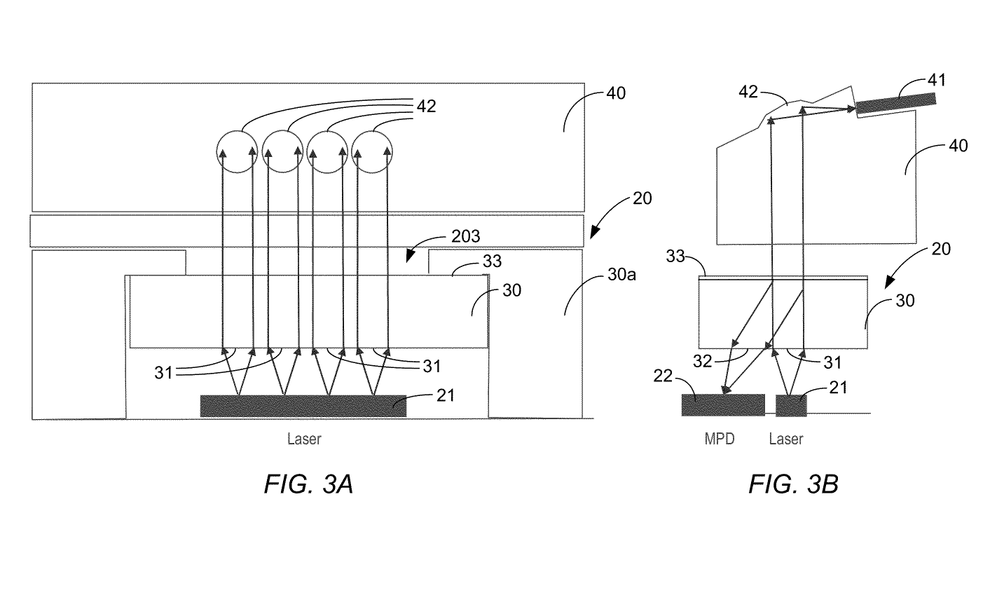

FIGS. 3A and 3B illustrate front and side plan views, respectively, of a parallel optical transmitter module 20 that includes an optical coupling system 30 in accordance with an illustrative embodiment of the invention. In FIG. 3A, a holder 30a for the optical coupling system 30 is shown, but in FIG. 3B the holder 30a has been removed for purposes of clarity. In accordance with this embodiment, the optical transmitter module 20 is a four-channel module having four laser diodes 21 and four monitor photodiodes 22. The laser diodes 21 are typically vertical cavity surface emitting laser diodes (VCSELs) arranged in an array in a single IC chip. The monitor photodiodes 22 are also arranged in an array on a single IC chip. The parallel optical transmitter module 20 typically also includes laser diode driver circuitry and controller circuitry, which are not shown for purposes of clarity. The parallel optical transmitter 20 is mechanically coupled to an optical connector 40 that holds ends of four optical fibers 41, although the mechanical coupling mechanism is not shown for purposes of clarity.

The optical coupling system 30 has four collimating lenses 31 and four focusing lenses 32 on its lower end and has a diffractive grating 33 formed on its upper end. The diffractive grating 33 may be a sinusoidal or blaze diffractive grating, as described above with reference to FIGS. 1A-2B, or it may be a diffractive grating having some other type of diffractive pattern formed in it that accomplishes the aforementioned optical goals. Each of the laser diodes 21 emits a diverging beam of light that is incident on a respective one of the collimating lenses 31. Each of the collimating lenses 31 collimates the respective diverging light beam into a respective collimated light beam. The respective collimated light beams are then incident on the diffractive grating 33. The diffractive grating 33 divides each of the collimated light beams into first and second collimated light beams. The first collimated light beams pass out of the optical coupling system 30 and are received in the optical connector 40. The first collimated light beams pass through the optical connector 40 and are incident on respective focusing lenses 42. The respective focusing lenses 42 focus the first collimated light beams onto respective ends of respective optical fibers 41.

The second collimated light beams are directed by the diffractive grating 33 onto the respective focusing lenses 32 formed on the lower end of the optical coupling system 30. The lenses 32 focus the respective second collimated light beams onto respective monitor photodiodes 22. The monitor photodiodes 22 convert the respective second collimated light beams into respective electrical signals, which are then fed back to electrical circuitry (not shown for purposes of clarity) of the parallel optical transmitter module 20 where they are used to adjust the bias and/or modulation currents of the respective laser diodes 21. The manner in which monitoring photodiodes and electrical feedback signals are used for this purpose is known in the art, and therefore will not be described herein in the interest of brevity.

The optical coupling system 30 is formed as a unitary, or integral, part. Although the invention is not limited with respect to the material of which the optical coupling system 30 is made, one of the advantages of the invention is that the unitary part 30 can be made of molded plastic relatively inexpensively using known plastic molding technologies. Making the unitary part 30 of molded plastic greatly reduces the cost of the optical coupling system while still allowing the aforementioned optical goals to be achieved. For this reason, the unitary optical coupling system 30 is preferably, but not necessarily, made of a molded plastic material.

It should be noted that although the optical coupling system 30 has been described with reference to being used in an optical transmitter module 20 that is mechanically coupled to a separate optical connector 40 that holds ends of four optical fibers 41, the optical transmitter module 20, the optical coupling system 30 and the optical connector 40 may be parts of a single module that terminates an end of an active optical cable. The optical connector 40 is shown as being a separate part for illustrative purposes.

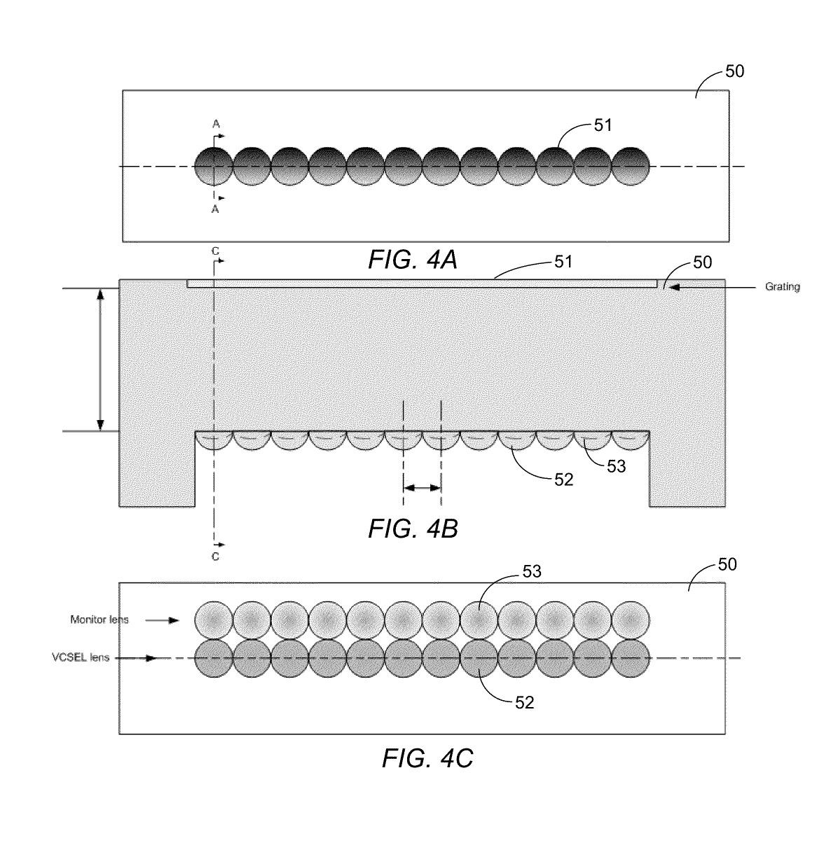

FIGS. 4A, 4B and 4C illustrate top, front and bottom plan views, respectively, of the optical coupling system 50 in accordance with an illustrative embodiment. In accordance with this embodiment, the optical coupling system 50 is configured to be used with a twelve-channel parallel optical transmitter module (not shown for purposes of clarity). In the top view of FIG. 4A, the diffraction grating 51 of the optical coupling system 50 can be seen. Circles are used to represent the diffraction grating 51, but the physical appearance of the diffraction grating 51 will depend on the diffractive pattern that is embedded in the grating 51, which can vary. In the front view of FIG. 4B, twelve collimating lenses 52 that are formed on the lower end of the optical coupling system 50 can be seen. In the bottom view shown in FIG. 4C, the collimating lenses 52 can be seen, and also twelve focusing lenses 53 can be seen.

When the optical coupling system 50 is implemented in a twelve-channel parallel optical transmitter module (not shown for purposes of clarity), twelve diverging light beams emitted from twelve VCSELs (not shown) are incident upon the respective collimating lenses 52. The collimating lenses 52 collimate the diverging beams into respective collimated beams, which are then incident on the diffractive grating 51. The diffractive grating 51 divides each collimated beam into first and second collimated beams. The first collimated beams pass out of the optical coupling system 50 and are received by an optics system (not shown) of a connector module (not shown) that holds the ends of twelve optical fibers (not shown). The optics system of the connector module directs the first collimated beams into the ends of the respective optical fibers. The second collimated beams are directed onto the respective focusing lenses 53, which focus the second collimated beams onto the respective monitor photodiodes.

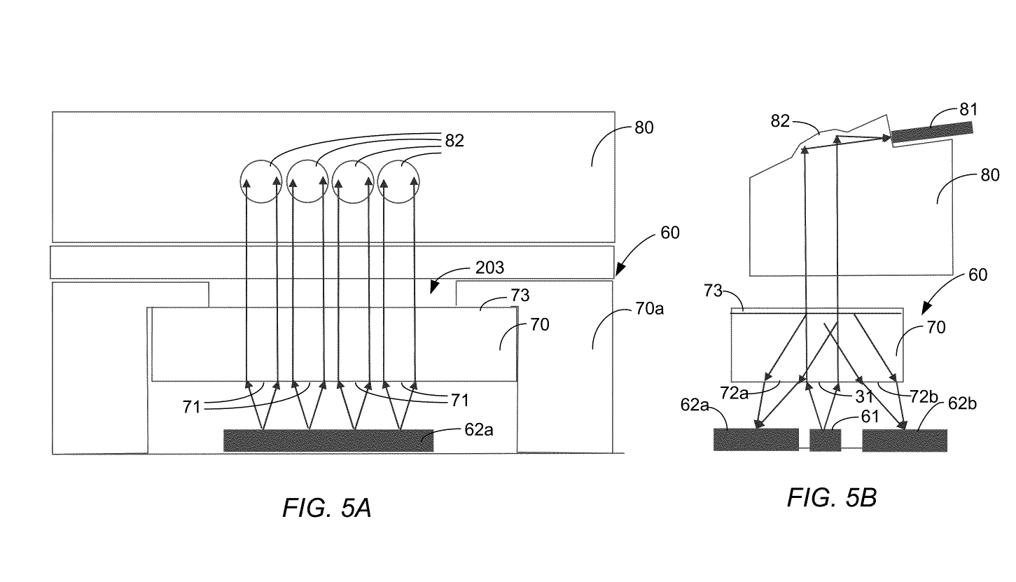

FIGS. 5A and 5B illustrate front and side views, respectively, of a four-channel optical transmitter module 60 mechanically coupled to an optical connector 80 that holds ends of four optical fibers 81. In accordance with this embodiment, the optical transmitter module 60 is a four-channel module having four laser diodes 61 and four monitor photodiodes 62. The primary difference between this embodiment and the embodiment described above with reference to FIGS. 3A and 3B is that the monitor photodiodes 62 of the module 60 shown in FIGS. 5A and 5B are located on both sides of the laser diodes 61. The monitor photodiodes 62 of the even-numbered channels are located on one side of the laser diodes 61 and the monitor photodiodes 62 of the odd-numbered channels are located on the opposite side of the laser diodes 61. The laser diodes 61 are typically VCSELs arranged in an array in a single IC chip. The monitor photodiodes 62 are also arranged in two arrays on two, respective, IC chips that are located on either side of the VCSEL chip that contains the array of VCSELs 61. The parallel optical transmitter module 60 typically also includes laser diode driver circuitry and controller circuitry, which are not shown for purposes of clarity.

The optical transmitter module 60 includes an optical coupling system 70 that has four collimating lenses 71 and four focusing lenses 72 on its lower end a diffractive grating 73 formed on its upper end. In FIG. 5A, a holder 70a for the optical coupling system 70 is shown, but in FIG. 5B the holder 70a has been removed for purposes of clarity. Two of the focusing lenses 72a are located on one side of the collimating lenses 71 and the other two focusing lenses 72b are located on the opposite side of the collimating lenses 71. The diffractive grating 73 may be a sinusoidal or blaze diffractive grating, as described above with reference to FIGS. 1A-2B, or it may be a diffractive grating having some other type of diffractive pattern formed in it that accomplishes the aforementioned optical goals. Persons of skill in the art will understand, in view of the description being provided herein, the manner in which various diffractive gratings may be designed and manufactured to achieve the aforementioned optical goals.

Each of the laser diodes 71 emits a diverging beam of light that is incident on a respective one of the collimating lenses 71. Each of the collimating lenses 71 collimates the respective diverging light beam into a respective collimated light beam. The respective collimated light beams are then incident on the diffractive grating 73. The diffractive grating 73 divides each of the collimated light beams into first and second collimated light beams, where the first collimated light beam corresponding to the 0T order and the second collimated light beam corresponding to the −1R order. The first collimated light beams pass out of the optical coupling system 70 and are received in the optical connector 80. The first collimated light beams are directed by an optics system (not shown) of the optical connector 80 onto respective focusing lenses 82. The respective focusing lenses 82 focus the first collimated light beams onto respective ends of respective optical fibers 81.

The second collimated light beams associated with the odd-numbered channels are directed by the diffractive grating 73 onto the focusing lenses 72a formed on the lower end of the optical coupling system 70. The second collimated light beams associated with the even-numbered channels are directed by the diffractive grating 73 onto the focusing lenses 72b formed on the lower end of the optical coupling system 70. The focusing lenses 72a focus the respective second collimated light beams onto respective monitor photodiodes 62a Likewise, the focusing lenses 72b focus the respective second collimated light beams onto respective monitor photodiodes 62b. The monitor photodiodes 62a and 62b convert the respective second collimated light beams into respective electrical signals, which are then fed back to electrical circuitry (not shown for purposes of clarity) of the parallel optical transmitter module 60 where they are used to adjust the bias and/or modulation currents of the respective laser diodes 61.

The optical coupling system 70 is formed as a unitary, or integral, part. Although the invention is not limited with respect to the material of which the optical coupling system 70 is made, one of the advantages of the invention is that the unitary part 70 can be made of molded plastic relatively inexpensively using known plastic molding technologies. Making the unitary part 70 of molded plastic greatly reduces the cost of the optical coupling system while still allowing the aforementioned optical goals to be achieved. For this reason, the unitary optical coupling system 70 is preferably, but not necessarily, made of a molded plastic material. Persons of skill in the art will understand, in view of the description being provided herein, the manner in which various diffractive gratings may be designed and manufactured in various other materials (e.g., glass) to achieve the aforementioned optical goals.

It should be noted that although the optical coupling system 70 has been described with reference to being used in an optical transmitter module 60 that is mechanically coupled to a separate optical connector 80 that holds ends of four optical fibers 81, the optical transmitter module 60, the optical coupling system 70 and the optical connector 80 may be parts of a single module that terminates an end of an active optical cable. The optical connector 80 is shown as being a separate part for illustrative purposes.

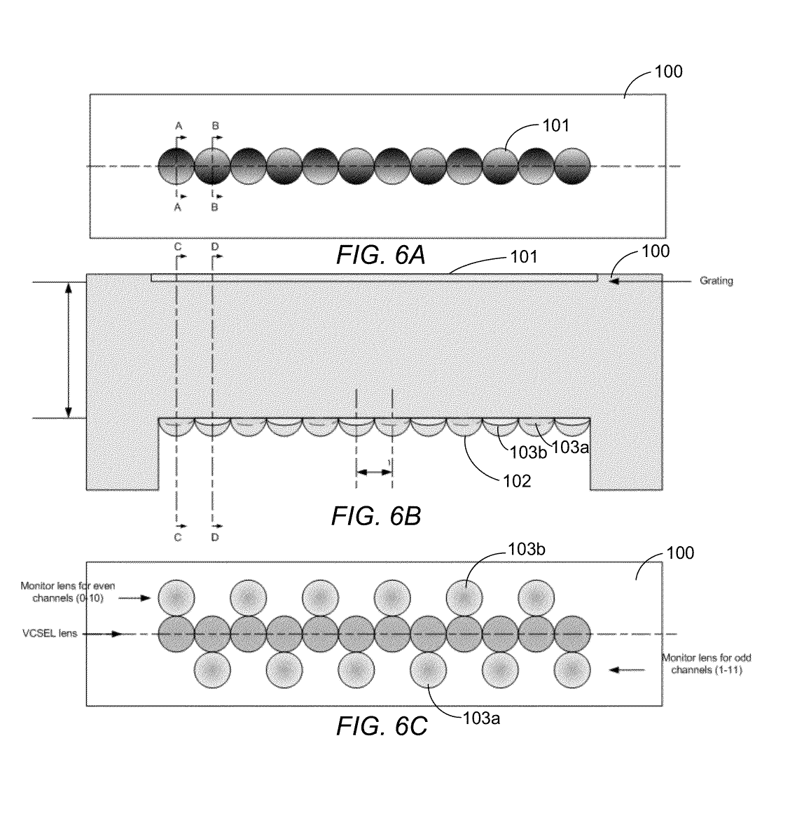

FIGS. 6A, 6B and 6C illustrate top, front and bottom plan views, respectively, of the optical coupling system 100 in accordance with an illustrative embodiment. In accordance with this embodiment, the optical coupling system 100 is configured to be used with a twelve-channel parallel optical transmitter module (not shown for purposes of clarity). In the tope view of FIG. 6A, the diffraction grating 101 of the optical coupling system 100 can be seen. Circles are used to represent the diffraction grating 101, but, as indicated above, the physical configuration of the diffraction grating 101 will depend on the diffractive pattern that is embedded in the grating 101, which can vary. In the front view of FIG. 6B, twelve collimating lenses 102 that are formed on the lower end of the optical coupling system 100 can be seen. In the bottom view shown in FIG. 6C, the collimating lenses 102 can be seen, and also twelve focusing lenses 103 can be seen. The focusing lenses 102 associated with the odd-numbered channels are located on one side of the focusing lenses 103 and the focusing lenses 102 associated with the even-numbered channels are located on the opposite side of the focusing lenses 103.

The primary difference between the optical coupling system 100 shown in FIGS. 6A-6C and the optical coupling system 50 shown in FIGS. 4A-4C is that the focusing lenses 103 are disposed on either side of the collimating lenses 102 in an alternating pattern that matches the arrangement of the monitor photodiodes (not shown) relative to the laser diodes (not shown) of the twelve-channel parallel optical transmitter module, which is not shown for purposes of clarity.

When the optical coupling system 100 is implemented in a twelve-channel parallel optical transmitter module, twelve diverging light beams emitted from twelve VCSELs (not shown) are incident upon the respective collimating lenses 102. The collimating lenses 102 collimate the diverging beams into respective collimated beams, which are then incident on the diffractive grating 101. The diffractive grating 101 divides each collimated beam into first and second collimated beams. The first collimated beams (the 0T orders) pass out of the optical coupling system 100 and are received by an optical coupling system (not shown) of a connector module (not shown) that holds the ends of twelve optical fibers (not shown). The optical coupling system of the connector module directs the first collimated beams into the ends of the respective optical fibers.

The second collimated light beams (the −1R orders) associated with the odd-numbered channels are directed by the diffractive grating 101 onto the focusing lenses 103a formed on the lower end of the optical coupling system 100. The focusing lenses 103a focus the respective second collimated light beams onto respective monitor photodiodes (not shown for purposes of clarity). The second collimated light beams (the −1R orders) associated with the even-numbered channels are directed by the diffractive grating 101 onto the focusing lenses 103b formed on the lower end of the optical coupling system 100. The focusing lenses 103b focus the respective second collimated light beams onto respective monitor photodiodes (not shown for purposes of clarity). The monitor photodiodes convert the respective second collimated light beams into respective electrical signals, which are then fed back to electrical circuitry (not shown for purposes of clarity) of the parallel optical transmitter module where they are used to adjust the bias and/or modulation currents of the respective laser diodes.

The optical coupling system 100 is formed as a unitary, or integral, part. Although the invention is not limited with respect to the material of which the optical coupling system 100 is made, one of the advantages of the invention is that the unitary part 100 can be made of molded plastic relatively inexpensively using known plastic molding technologies. Making the unitary part 100 of molded plastic greatly reduces the cost of the optical coupling system while still allowing the aforementioned optical goals to be achieved. For this reason, the unitary optical coupling system 100 is preferably, but not necessarily, made of a molded plastic material. As indicated above, persons of skill in the art will understand, in view of the description being provided herein, the manner in which various diffractive gratings may be designed and manufactured to achieve the aforementioned optical goals.

As indicated above, the diffractive grating preferably is also designed and manufactured to minimize polarization dependence of the 0T orders, which, in turn, reduces or eliminates polarization-dependent noise that may otherwise occur when the mode composition of the laser diode emission changes. Reducing or eliminating polarization-dependent noise minimizes mode-selective loss. This is accomplished by ensuring that the difference between the 0T order for the transverse electric (TE) mode and the 0T order for the transverse magnetic (TM) mode is small. With reference again to FIGS. 1A and 1B, a sinusoidal diffractive grating having the depth, D, and the period, P, described above with reference to FIGS. 1A and 1B has a 0T order TE mode diffraction efficiency of about 88.5% and a 0T order TM mode diffraction efficiency of about 89.1%, or a diffraction efficiency difference of about 0.6%. This means that the difference between the transmitted optical power for the TE and TM modes is very small, which means that polarization-dependent noise is very small. Keeping polarization-dependent noise very small minimizes mode-selective loss.

The same is true for the diffractive grating that uses the blaze diffractive pattern shown in FIGS. 2A and 2B. Using the blaze diffractive grating having the depth, period and angle described above with reference to FIGS. 2A and 2B achieves a 0T order TE mode diffraction efficiency of about 87.8% and a 0T order TM mode diffraction efficiency of about 88.6%, or a diffraction efficiency difference of about 0.8%. This means that the difference between the transmitted optical power for the TE and TM modes is very small, which means that polarization-dependent noise is very small. As indicated above, keeping polarization-dependent noise very small minimizes polarization-dependent loss.

From the above description of the illustrative embodiments, it can be seen that an optical coupling system can be made as a unitary part at relatively low cost while still achieving the aforementioned optical goals of: (1) minimizing the optical power that is contained in higher diffractive orders so that the optical power that is contained in the 0T and the −1R orders is maximized (i.e., the light to be coupled into the end of the optical fiber and the light that is to be used for feedback monitoring); (2) minimizing the amount of optical power that is contained in the 0R orders (i.e., the light that might otherwise be coupled into the aperture of the laser diode as optical crosstalk); and (3) minimizing polarization dependence of the 0T orders in order to minimize polarization-dependent loss. It should be noted that these optical goals are achieved without the need for using reflective coatings for reflecting the light to be used for feedback monitoring and without the need for using light-absorbing materials to reduce or eliminate optical crosstalk in the laser diode.

Illustrative embodiments of the O-Q cover will now be described with reference to FIGS. 7A-8. FIGS. 7A and 7B illustrate front and side plan views, respectively, of a parallel optical transmitter module 200 that includes an O-Q cover 210 that is not included in the parallel optical transmitter module 20 shown in FIG. 3A. The parallel optical transmitter module 200 shown in FIGS. 7A and 7B is identical to the parallel optical transmitter module 20 shown in FIGS. 3A and 3B except that the module 200 shown in FIGS. 7A and 7B is equipped with the O-Q cover 210, and the holder 220 of the optical coupling system 30 has been modified from the holder 30a shown in FIG. 3A to hold the O-Q cover 210 and the optical coupling system 30 in a predetermined spatial relationship relative to one another. In FIG. 7B, the holder 220 has been removed for clarity.

In the illustrative embodiments of the modules shown in FIGS. 3A, 3B, 5A, and 5B, there is an air gap 203 above the diffractive gratings 33 and 73. The parallel optical transmitter modules 20 and 60 are typically not hermetically sealed, although they do typically include features that help reduce the amount of contaminants that enter the modules. Environmental contaminants such as dust and water vapor can collect on the upper surfaces of the diffractive gratings 33 and 73. Because the upper surfaces of the gratings 33 and 73 have very fine structures on them, contaminants can collect on these surfaces. During operations, these contaminants can affect the optical performance of the gratings 33 and 73, and thereby detrimentally affect the performance of the modules 20 and 60. The O-Q cover 210 seals the diffractive grating 33 from the environment to prevent such contaminants from collecting on the upper surface of the grating 33, as will now be described with reference to FIGS. 7A-8.

With reference again to FIG. 7A, the holder 220 has a recessed area 221 formed in its upper surface 220a for holding the O-Q cover 210. An opening formed in the recessed area 221 defines a ledge 221a in the holder 220. Peripheral portions of a lower surface 210a of the O-Q cover 210 sit on the ledge 221a. The ledge 221a provides standoffs that space the lower surface 210a of the O-Q cover 210 a predetermined distance, D, away from the diffractive grating 33. The O-Q cover 210 has an upper surface 210b that is parallel to the lower surface 210a of the cover 210. At least a portion 210c of the O-Q cover 210, defined for effect by lines 210d, corresponds to an optical window of the cover 210 that is transparent to the operating wavelength(s) of the module 200 to allow light of the operating wavelength(s) to pass through the optical window 210c.

The distance D must be a least great enough that the lower surface 210a of the cover 210 is not in contact with the grating 33. The upper and lower surfaces 210a and 210b of the cover 210 are parallel to one another and the material of which the cover 210 is made is sufficiently strong so that the stress applied to the cover 210 during operation of the module 200 will not bend the surfaces 210a and 210b to the point that a lens effect occurs, i.e., to the point that the cover 210 begins to operate on the light as a lens. Some degree of bending may be tolerable, but too much bending can result in an intolerable amount of optical attenuation, and consequently, an unacceptable reduction in optical coupling efficiency. Also, the lower and upper surfaces 210a and 210b, at least within the optical window 210c, should be both sufficiently flat and smooth to prevent the cover 210 from having any refractive, diffractive or reflective effect on the light beams passing through the window 210c. Providing the cover 210 with all of these properties ensures that it will have the necessary or desired optical quality. A variety of materials and manufacturing techniques may be used to make a cover 210 having these properties of transparency, parallelism, flatness and smoothness, and persons of skill in the art will understand how to make a cover having these properties.

The cover 210 has a thickness that typically ranges from about 0.1 millimeters (mm) to about 0.5 mm and is typically about 0.3 mm. The thickness is chosen to be sufficiently great that the cover 210 is strong enough to prevent it from being bent to an impermissible extent, and at the same time, small enough to prevent the cover 210 from introducing an unacceptable amount of optical attenuation. The thickness T will depend on properties of the material that is used to make the cover 210 because materials that are more absorptive to light of the operating wavelength(s) will need to be thinner than materials that are less absorptive to light of the operating wavelength(s). Also, the lower surface 210a and/or the upper surface 210b of the cover 210 may be coated with an anti-reflection (AR) coating (not shown) to prevent light from being reflected at these surfaces. Persons of skill in the art will understand how a suitable material having a suitable thickness may be chosen for this purpose. The cover 210 is typically made of a thermoplastic material such as ULTEM PEI, which is manufactured by Saudi Basic Industries, Corp. (SABIC) of Saudi Arabia. Other materials having the desired optical properties, such as glass, PES, and HTLT™, for example, may also be used for this purpose.

FIG. 8 illustrates a cross-sectional side view of the cover 210, the holder 220 and the optical coupling system 30 shown in FIG. 7A. In accordance with an illustrative embodiment, the optical coupling system 30 and the cover 210 are secured via an adhesive material 230, such as epoxy, to the holder 220. A peripheral portion of the upper surface of the optical coupling system 30 on which the grating 33 is disposed is secured via the adhesive material 230 to an upper inner surface 220b of the holder 220. The side walls of the optical coupling system 30 are secured via the adhesive material 230 to inner side walls 220c of the holder 220. A peripheral portion of the lower surface 210a of the cover 210 is secured via the adhesive material 230 to the ledge 221a formed in the holder 220. By using the adhesive material 230 in the locations shown in FIG. 8, the cover 210, the holder 220 and the adhesive material 230 provide a hermetically sealed compartment about the grating 33 that protects the grating 33 from contaminants such as dust and water vapor. It should be noted, however, that it is not necessary in all cases for the seal that exists between the holder 220 and the cover 210 to be a hermetical seal. In some cases, a snug fit between the cover 210 and the holder 220 will be sufficient to protect the grating 33 from external environmental contaminants. It should also be noted that securing devices or mechanisms other than adhesive material, such as clips, springs, or welded joints, may be used to secure the optical coupling system 30 and the cover 210 to the holder 220.

It should be noted that the invention has been described with reference to a few illustrative embodiments for the purpose of demonstrating the principles and concepts of the invention. It will be understood by persons of skill in the art, in view of the description provided herein, that the invention is not limited to these illustrative embodiments and that many variations can be made to the illustrative embodiments without deviating from the scope of the invention. For example, while the cover 210 has been described for exemplary purposes as being flat in shape, persons of skill in the art will understand the manner in which the principles and concepts of the invention may be applied to provide a cover that achieves the aforementioned optical goals. Also, while the cover has been described with reference to being used in a parallel optical transmitter module, it may be used in a parallel optical receiver or transceiver module or in other types of parallel and non-parallel (i.e., single channel) optical communications modules.

What is claimed is:

1. An optical communications module comprising:
a holder for holding an optical coupling system, the holder having an upper surface in which a recessed area has been formed, the recessed area having an opening formed therein that defines a ledge;
an optical coupling system secured to the holder beneath the opening, the optical coupling system being transparent to light of an operating wavelength, the optical coupling system having at least an upper surface, a lower surface, and side walls, wherein a diffractive grating is formed in the upper surface of the optical coupling system;
at least one optoelectronic component disposed beneath the optical coupling system; and
an optical-quality (O-Q) cover secured to an upper surface of the ledge such that the cover covers the opening formed in the recessed area of the holder, the cover being transparent to light of an operating wavelength, the diffractive grating being spaced apart from the lower surface of the cover by a predetermined distance, D, wherein the cover protects the diffractive grating from contaminants in an environment external to the optical communications module.

2. The optical communications module of claim 1, wherein the O-Q cover has upper and lower surfaces that are parallel to one another, the upper and lower surfaces of the cover being smooth and flat in an optical window portion of the cover.

3. The optical communications module of claim 2, wherein the side walls of the optical coupling system are in contact with respective inner side walls of the holder, and wherein an adhesive material is disposed in between the side walls of the optical coupling system and the respective inner side walls of the holder, and wherein the adhesive material secures the optical coupling system to the holder.

4. The optical communications module of claim 3, wherein an adhesive material is disposed in between the upper surface of the ledge and the lower surface of the cover, and wherein the adhesive material secures the cover to the holder.

5. The optical communications module of claim 4, wherein a hermetically-sealed compartment is formed by securing the side walls of the optical coupling system to the respective inner side walls of the holder with the adhesive material and by securing the upper surface of the ledge to the lower surface of the cover with the adhesive material, and wherein the diffractive grating is disposed within the hermetically-sealed compartment.

6. The optical communications module of claim 2, wherein the cover is made of a plastic material.

7. The optical communications module of claim 6, wherein the plastic material is polyetherimide.

8. The optical communications module of claim 7, wherein the cover has a thickness that is selected to ensure that the cover does not bend to an extent that causes the cover to have a lens effect on light of the operating wavelength passing through the cover.

9. The optical communications module of claim 8, wherein the thickness is in a range of from about 0.1 millimeters (mm) to about 0.5 mm.

10. The optical communications module of claim 2, wherein the cover is made of glass.

11. The optical communications module of claim 2, wherein the optical coupling system is a unitary part, the unitary part having one or more lenses formed on the lower surface of the body opposite the diffractive grating formed on the upper surface of the optical coupling system.

12. The optical communications module of claim 11, the optical coupling system is made of a plastic material.

13. The optical communications of claim 12, wherein the plastic material is polyetherimide.

14. The optical communications module of claim 11, wherein at least one of the lenses is a collimating lens and at least one of the lenses is a focusing lens.

15. The optical communications module of claim 14, wherein the optical communications module is a parallel optical communications module, and wherein the module comprises a plurality of optoelectronic components.

16. The optical communications module of claim 15, wherein the parallel optical communications module is a parallel optical transmitter module, and wherein the plurality of optoelectronic components include a plurality of laser diodes.

17. The optical communications module of claim 16, wherein the plurality of optoelectronic components include a plurality of monitor photodiodes, and wherein a plurality of the lenses are collimating lenses and a plurality of the lenses are focusing lenses, and wherein the collimating lenses collimate respective light beams produced by the respective laser diodes and direct the collimated light beams onto the diffractive grating, and wherein the focusing lenses receive respective reflected portions of the collimated light beams directed onto the diffractive grating and focus the respective reflected portions of the collimated light beams onto the respective monitor photodiodes.

18. The optical communications module of claim 17, wherein the diffractive grating divides each collimated light beam directed thereon into at least first and second collimated light beams, the first collimated light beam being transmitted through the diffractive grating and through the cover, the second collimated light beams corresponding to the respective reflected portions that are focused by the respective focusing lenses onto the respective monitor photodiodes.

19. The optical communications module of claim 2, wherein the parallel optical communications module is a parallel optical receiver module, and wherein the plurality of optoelectronic components include a plurality of photodiodes.

20. The optical communications module of claim 2, wherein the parallel optical communications module is a parallel optical transceiver module, and wherein the plurality of optoelectronic components include a plurality of laser diodes and a plurality of photodiodes.
